(19) United States
(12) Patent Application Publication
(10) Pub. No.: US 2009/0097400 A1
(43) Pub. Date: Apr. 16, 2009

(54) Method of Restoring a Ring System

(75) Inventor: Pedro Ricardo de Frias Rebelo Nunes, Linda-A-Velha (PT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Nokia Siemens Networks GmbH & Co. KG

(21) Appl. No.: 11/793,864

(22) PCT Filed: Dec. 19, 2005
(86) PCT No.: PCT/EP05/56906

§ 371 Date: May 8, 2008

(30) Foreign Application Priority Data
Dec. 22, 2004 (GB) 0428028.5

(51) Int. Cl. G06F 11/00

(52) U.S. Cl. 370/225

(57) ABSTRACT

In a system comprising nodes linked in a ring structure where data flows between the nodes, a method of operating the system after a link has become broken, comprising recovering the broken link and the system treating the recovered link as still broken and operating the system so as to block the recovered link. One of the nodes in the ring system is a redundancy manager node which sends messages to the other nodes to implement blocking of the recovered link. Only when another link becomes broken does the system start to use the previously recovered link.

This invention relates to a method of restoring a link in a system where the system comprises a number of node joined by links and is applicable to telecommunication systems and in particular Ethernet based systems.

Ethernet ring protection always creates traffic/service interruption when a broken link is restored and is created when the system switches back to normal position.

Ethernet ring protection always creates traffic/service interruption when a broken link is restored and the system switches back to normal position.

One of the nodes in an ERP ring is the redundancy manager (RM) node, which is responsible to co-ordinate blocking or unblocking of ERP ring links in order to create a loop-less topology.

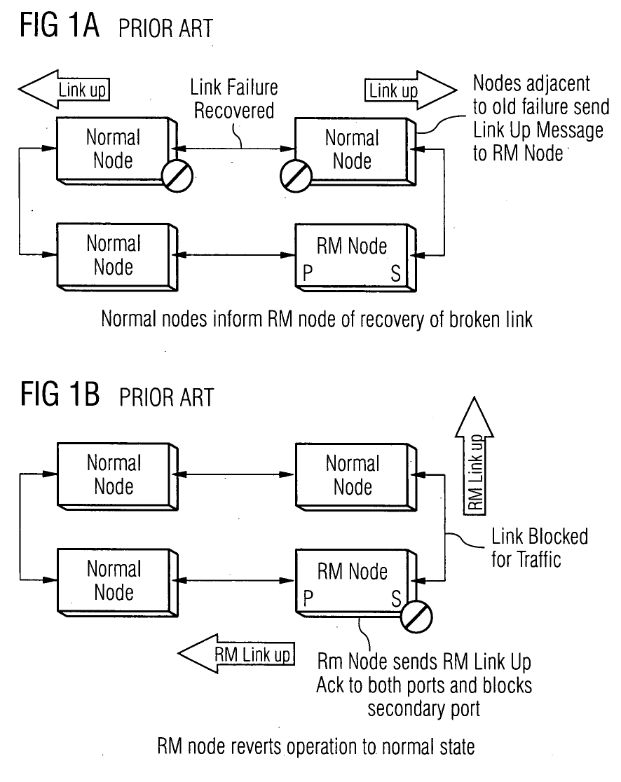

From time to time links become broken and when the broken link becomes once again operational, the nodes adjacent to the link sent a “link up” notification to the RM node. The RM node in turn blocks one of its ports and sends an indication for the normal modes that the ring is re-established. This indication makes all nodes revert to normal state. This step unfortunately causes traffic and service interruption, triggered by e.g. flushing and filtering databases (MAC look-up tables) in all the nodes of the whole ring. This is shown in FIG. 1.

It is there for an object of the invention to overcome this problem.

By enhancing the protocol on the RM node it is possible to thus avoid the traffic interruption when the broken link is restored and still provide protection if another link is broken.

The invention comprises in a system comprising nodes linked in a ring structure where data flows between the nodes, a method of operating the system after a link has become broken, comprising recovering said broken link, and the system treating said recovered link as still broken and operating said system so as to block said link. One of said nodes in said ring system is a redundancy manager node which sends messages to the other nodes to implement blocking of said recovered link. The recovered link is treated as blocked until failure of another link occurs.

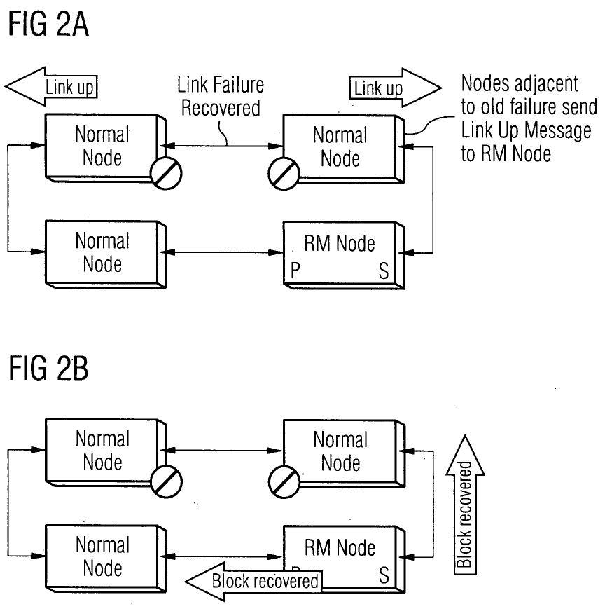

The invention will now be described with reference to FIG. 2 which shows a basic embodiment of the invention; the system hardware is identical to that of FIG. 1.

When a broken link becomes once more operational, the nodes adjacent to the link send the information to the RM node that the link is recovered, or the RM node it self perceives that the link is recovered. The RM node instead of sending an indication to the normal nodes to use the recovered link, sends them an indication to keep blocking the link; this way a new traffic interruption is avoided. When a new failure on another link occurs, the link down indication set by the nodes adjacent to the link will make the link usable once again.

1.-6. (canceled)

7. A method of operating a system after a link has been broken, the system comprising nodes linked in a ring structure where data flows between the nodes, the method comprising:
recovering said broken link;
treating, by the system, said recovered link as still broken; and
operating said system so as to block said link.

8. The method as claimed in claim 7, wherein said recovered link is treated as blocked until failure of another link occurs.

9. The method as claimed in claims 7, wherein said system is a computer.

10. The method as claimed in claims 7, wherein said system is a telecommunication system.

11. The method as claimed in claim 7, wherein one of said nodes in said ring system is a redundancy manager node which sends messages to the other nodes to implement blocking of said recovered link.

12. The method as claimed in claim 11, wherein said recovered link is treated as blocked until failure of another link occurs.

13. The method as claimed in claims 12, wherein said system is a computer or telecommunication system.

14. The method as claimed in claim 13 wherein said system is an Ethernet based system.

15. A system, comprising:
a plurality of links including a link recovered from being broken;
a plurality of nodes linked in a ring structure via the plurality of links such that data flows between the nodes recovering said broken link;
wherein said recovered link is treated as still broken; and
wherein the system continues to block said recovered link.

16. The system as claimed in claim 15, wherein said recovered link is treated as blocked until failure of another link occurs.

17. The system as claimed in claim 15, wherein one of said nodes in said ring system is a redundancy manager node which sends messages to the other nodes to implement blocking of said recovered link.

18. The system as claimed in claims 15, wherein said system is a telecommunication system.
